(19) United States
(12) Patent Application Publication
(10) Pub. No.: US 2005/0160462 A1
(43) Pub. Date: Jul. 21, 2005

(54) Signal generating method, program, and storing apparatus for automatically storing broadcast programs

(75) Inventors: Yasushi Shikata, Sagamihara-shi (JP); Kazuna Maruyama, Tokyo (JP); Yoshikazu Shibamiya, Tokyo (JP); Kazuhiro Matsubayashi, Yokohama-shi (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 11/008,284

(22) Filed: Dec. 10, 2004

(30) Foreign Application Priority Data
Dec. 11, 2003 (JP) 2003-412775(PATEN
Nov. 30, 2004 (JP) 2004-346614(PATEN

(51) Int. Cl. H04N 5/445; G06F 3/00; H04N 7/10; H04N 7/025; G06F 13/00

(52) U.S. Cl. 725/58; 725/35; 725/34; 725/46

(57) ABSTRACT

A signal generating method includes a step of determining broadcast programs to be stored in a storing apparatus during a predetermined time period; a step of determining broadcast programs, from the broadcast programs stored in the storing apparatus, to be deleted during the predetermined time period; and a step of generating signals for simultaneously displaying information on the broadcast programs to be stored and information on the broadcast programs to be deleted.

### BACKGROUND OF THE INVENTION

1. Field of the Invention

The present invention relates to a storing apparatus for storing a plurality of broadcast programs.

2. Description of the Related Art

Besides VHS and DVD systems, an increasing number of storing apparatuses use hard disks serving as media for recording broadcast programs these days. A hard disk allows random access to the data stored thereon. In addition the input of digital signals to the hard disk causes no degradation in image quality. Moreover, since the hard disk allows recording and playback to be performed simultaneously new viewing methods for easing temporal constraints, such as pausing and time-shift playback of a program being viewed, can be offered tag viewers. Furthermore, with an increase in hard disk capacity year by year, the number of programs that can be recorded has increased. It is possible that a storing apparatus having several hundred GB of hard disk may be put into practical use shortly.

With broadcasting satellite (BS) and communications satellite (CS) broadcasts accelerating the increase in the number of broadcast programs, viewers are more likely to miss programs of interest. To avoid missing such programs, some storing apparatuses with hard disks allow viewers to register keywords, and programs containing program-related information that matches the registered keywords can be automatically recorded (see Japanese Patent Laid-Open No-2000-155997). The program-related information is obtained from broadcast data or via the Internet. Such a function cannot be effectively performed without a large-capacity hard disk. That is, an increased capacity of hard disk is required for viewers to reliably record programs of interest. A number of problems arise with the keyword approach.

One problem Is that keyword setting is cumbersome for viewers. If the appropriate keywords are set, viewers record just their desired programs. However, keyword setting must be repeatedly performed if the keywords set are inappropriate.

A second problem relates to effective use of the hard disk An :injudicious choice of keywords may cause a number of undesired programs to be recorded, and the upper limit of the hard disk capacity may be reached in a short time. If the upper limit is reached, programs recorded in a storing apparatus need to be deleted to record additional programs. An example of a method for deleting programs include, when the upper limit of the hard disk capacity is reached, interrupting recording and deleting recorded programs in chronological order of their recorded date and time. However, there is a risk that such a method may interfere with recording of desired programs or may accidentally delete desired programs already stored. Another possible method includes determining individually whether or not stored programs should be deleted, and automatically deleting some programs based on the determination. However, such a method creates another task of determining whether or not each program should be deleted.

A third problem is that when the same keyword is used for a long period of time, it may become difficult for viewers to keep track of the programs newly recorded in the recording apparatus before being viewed or played back. In this case, it cannot be ensured that the Intended programs are reliably recorded.

Japanese Patent Laid-Open No. 2003-259284 discloses a recording apparatus for recording broadcast signals. The recording apparatus presents a list of deleting options to the user when the free space available in its storing unit is limited.

### SUMMARY OF THE INVENTION

The present application describes an invention for providing a preferred structure related to deletion of stored programs.

According to one aspect of the present invention, a signal generating method includes a step of determining broadcast programs to be stored in a storing apparatus during a predetermined time period. The method also includes a step of determining broadcast programs, from the broadcast programs stored in the storing apparatus, to be deleted during the predetermined time period. The method also includes a step of generating signals for simultaneously displaying Information on the broadcast programs to be stored and information on the broadcast programs to be deleted.

The step of determining broadcast programs to be stored may be performed based on one of a setting, made by a user, of the storing apparatus, and a history of the setting made by the user.

The step of determining broadcast programs to be deleted may be performed based on at least one of a setting made by a user, of the storing apparatus, a history of the setting made by the user, and a playback history of the broadcast programs stored in the storing apparatus.

According to another aspect of the present invention, a signal generating method includes a step of determining a date, time, or both a date and time, for deleting broadcast programs stored in a storing apparatus. The method also includes a step of generating signals for displaying the date, time, or both the date and time, for deleting the broadcast programs.

The signal generating method may further include a step of changing the date, time, or both, for deleting the broadcast programs.

The broadcast programs to be deleted are selected from a plurality of broadcast programs stored in the storing apparatus, as broadcast programs to be deleted. The method may further include a step of changing a deleting schedule for the selected broadcast programs. Changes of the deleting schedule include a cancellation of the deleting schedule, a change of the scheduled date or time of deletion, and a change of the scheduled date and time of deletion.

According to still another aspect of the present invention, a program for signal generation includes a step of determining broadcast programs to be stored. In a storing apparatus, during a predetermined time period. The method also includes a step of determining broadcast programs, from the broadcast programs stored in the storing apparatus, to be deleted during the predetermined time period. The method also includes a step of generating control signals for simultaneously displaying information on the broadcast programs to be stored and information on the broadcast programs to be deleted.

According to yet another aspect of the present invention, a program for signal generation includes a step of determining a date, time, or both, for deleting broadcast programs stored in a storing apparatus. The method further includes a step of generating control signals for displaying a date, time, or both, for deleting the broadcast programs.

According to yet another aspect of the present invention, a storing apparatus for storing broadcast programs, includes a storing device for storing broadcast programs. The apparatus also includes a control circuit for determining broadcast programs to be stored in the storing device during a predetermined time period. The control circuit also determines broadcast programs, from the broadcast programs stored in the storing device, to be deleted during a predetermined time period. The control circuit also generates control signals for simultaneously displaying information on the broadcast programs to be stored and information on the broadcast programs to be deleted.

According to a further aspect of the present invention, a storing apparatus for storing broadcast programs includes a storing device for storing broadcast programs and a control circuit for determining a date, time, or both, for deleting the broadcast programs stored in the storing device.

According to yet another aspect of the present invention, a display apparatus includes a control circuit and display device. The control circuit determines broadcast programs to be stored, in a storing device, during a predetermined time period. The control circuit also determines broadcast programs, from the broadcast programs stored in the storing device, to be deleted during the predetermined time period. The control circuit also generates control signals for simultaneously displaying information on the broadcast programs to be stored and information on the broadcast programs to be deleted. The display device displays according to the control signals.

According to yet another aspect of the present invention, a display apparatus includes a control circuit for determining a date, time, or both a date and time, for deleting broadcast programs stored in a storing device. The apparatus also includes a display device for displaying a date, time, or both, for deleting the broadcast programs stored in the storing device

Further objects, features and advantages of the present inventor will become apparent from the following description of the preferred embodiments with reference to the attached drawings.

### BRIEF DESCRIPTION OF THE DRAWINGS

FIG. 1 is a block diagram of a storing apparatus as one aspect of the present invention.

FIG. 2 is a flowchart showing a program-storing process as another aspect of the present invention.

FIG. 3 is a detailed flowchart showing the process of schedule creation at step S201 in FIG. 2.

FIG. 4 is a detailed flowchart showing the process of schedule presentation at step S202 in FIG. 2.

FIG. 5 is an example of the presentation of a storing schedule and deleting schedule.

FIG. 6 is an example of the presentation of sub-options of storing programs and sub-options of deleting programs.

FIG. 7 is a detailed flowchart showing the process of schedule re-creation at step 5204 in FIG. 2.

### DESCRIPTION OF THE PREFERRED EMBODIMENTS

Embodiments of the present invention will now be described. In the following embodiments, an automatic recording operation based on keywords is performed in consideration of problems described above.

The embodiments described below show a storing method and apparatus capable of allowing viewers to see, with an easy setting operation, programs to be stored or deleted in advance, thus enabling the storage capacity of the hard disk to be efficiently used.

A storing method as one embodiment of the present invention is a storing method for automatically storing a plurality of broadcast programs in a storing apparatus, and includes a storing-schedule creating step of creating a storing schedule for storing the broadcast programs during a predetermined time period. The method also includes a deleting-schedule creating step of creating a deleting schedule for deleting, during the same time period as the above-described predetermined time period, some of the broadcast programs stored in the storing apparatus. The method further includes a presenting step of presenting, at a predetermined timing, the storing schedule and the deleting schedule created in the storing-schedule creating step and the deleting-schedule creating step, respectively. The method also includes a changing step of changing contents of the storing schedule and the deleting schedule that are presented in the presenting step. In addition, a re-creating step re-creates the deleting schedule based on the contents changed in the changing step.

Another embodiment of the present invention, a storing apparatus, automatically stores a plurality of broadcast programs. The apparatus includes a program-related-information storing unit for storing program-related information, which is information related to the plurality of broadcast programs. The apparatus also includes an operating history controller for maintaining histories related to storing and playback of the plurality of broadcast programs as operating history information, based on the program-related information and operating history information, which is information related to recording and playback of the plurality of broadcast programs. A profile generator in the apparatus analyzes the operating history information to generate profile information, generates a storing schedule, which is a list of the plurality of broadcast programs to be stored during a predetermined time period, and also generates a deleting schedule, which is a list of some of the plurality of stored broadcast programs to be deleted. A schedule controller in the apparatus controls the storing schedule and deleting schedule to be displayed at a predetermined timing.

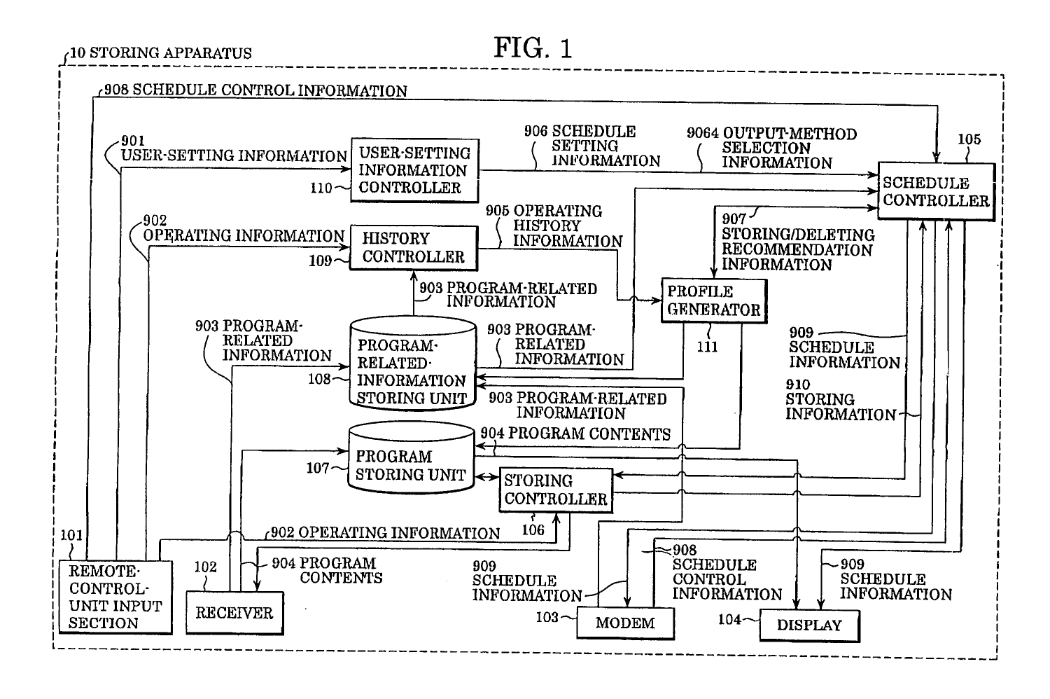

Preferred embodiments of the present invention will now be described with reference to the accompanying drawings. FIG. 1 is a block diagram showing the structure of a storing apparatus 10 as one aspect of the present invention.

The storing apparatus 10 is not only a storing apparatus having a program-storing unit 107 serving as a storing device, but also a display apparatus having a display 104 serving as a display device. The display 104 may be a cathode-ray tube (CRT) panel, a plasma display panel, a liquid crystal display panel, and a display panel in which field emission elements are arranged. The storing apparatus 10 also has a control circuit including a schedule controller 105 and a history controller 109. The storing apparatus 10 is capable of receiving digital broadcasts or analog broadcasts via a receiver 102. When information related to programs (hereinafter referred to as “program-related information 903”) is multiplexed in broadcast data, the storing apparatus 10 receives the program-related information 903 via the receiver 102. The program-related information 903 is equivalent to, for example, service information (SI) multiplexed in broadcast data for BS digital broadcasts before being sent. In the present embodiment, the program-related information 903 includes information such as a program-starting time and the total capacity of a program other than the SI.

The program storing unit 107 and a program-related-information storing unit 108, which are included in the storing apparatus 10, store programs received via the receiver 102 (hereinafter referred to as “program contents 904”) arm the program-related information 903, respectively. Although the program storing unit 107 is a hard disk in the present embodiment, it is not limited to a hard disk. Similarly, although the program-related-information storing unit 108 is a semiconductor memory in the present embodiment, it is not limited to a semiconductor memory.

The storing apparatus 10 includes a modem 103. The program-related information 903 may exist in a specific site on the Internet. In this case, the program-related information 903 is accessed and downloaded from the Internet via the modem 103. The program-related information 903 obtained via the modem 103 is also stored in the program-related-information storing unit 108.

For a viewer to perform a normal recording operation, a remote control unit (not shown) is used to make settings. A keyboard or a mouse may be used, instead. When the viewer sets up a schedule for recording programs, this operation is transmitted, as operating information 902, via a remote-control-unit input section 101 to a storing controller 106. The operating information 902 includes not only recording-related information but also information for instructions to play back programs stored in the program storing unit 107. In the case where the storing apparatus 10 has a normal function of television reception, the operating information 902 further includes information for channel selection instructions.

The storing controller 106 receives the operating information 902 from the remote-control-unit input section 101. When the operating information 902 received is information for a recording schedule, the storing controller 106 sends a request to the receiver 102, at a designated time, to receive an appropriate channel, performs predetermined processing on the program contents 904 received, and stores the program contents 904 in the program storing unit 107 The predetermined processing refers to, for example, input format conversion and image processing. If there is no free space available in the program storing unit 107 for storing the program contents 904, this fact is indicated to the viewer or programs stored in the program storing unit 107 are deleted.

For the, viewer to play back the program contents 904 stored the operating information 902 for playback instructions is transmitted via the remote-control-unit input section 101 to the storing controller 106. On receipt of the operating information 902, the storing controller 106 sends the appropriate program stored in the program storing unit 107 to the display 104 to be displayed. Although the display 104 in FIG. 1 is shown as a part of the storing apparatus 10, the display 104 may be an external unit. In such a case, the storing apparatus 10 includes an output interface to the display 104.

The history controller 109 maintains and controls the viewer's histories of recording and playback of the program contents 904 stored (hereinafter referred to as “operating history information 905”) based on the operating information 902 and the program-related information 903 stored in the program-related-information storing unit 108.

A profile generator 111 generates profile information according to an analysis of the viewer's preferences based on the operating history Information 905 stored in the history controller 109. When a specific time period is designated, the profile generator 111 extracts the appropriate program-related information 903 from the program-related-information storing unit 108 to creates a list of recommended programs for the viewer based on the generated profile information. In such a program list, programs for a designated time period are arranged in order of recommendation. Moreover, when a certain time period is designated, the profile generator 111 extracts programs for the designated time period from a group of the program contents 904 stored in the program storing unit 107 to create a deletion list.

A user-setting information controller 110 controls information for settings made by the viewer (hereinafter referred to as “user setting information 901”). The user setting information 901 includes a variety of setting information defined in the storing apparatus 10 by the viewer. As shown in FIG. 1, the information may be sent as the user setting information 901 to the user-setting information controller 110 via the remote-control-unit input section 101, or via input buttons (not shown) that may be provided in the storing apparatus 10 to perform settings.

The schedule controller 105 creates a storing schedule and deleting schedule for a specific time period (hereinafter referred to as “schedule information 909”). To create such schedules, the schedule controller 105 first obtains schedule setting information 906 from the user-setting information controller 110. The schedule setting information 906 is information set by the viewer and Includes the duration for schedule creation, and the timing of the schedule creation and output.

When the schedule setting information 906 is received from the user-setting information controller 110, the schedule controller 105 starts creating the schedule information 909 at the timing defined by the schedule setting information 906.

The storing schedule, which is included in the schedule information 909, is created by having the profile generator 111 extract recommended programs from a group of programs for a specific time period designated by the schedule setting information 906. Information for such a group of programs is stored in the program-related-information storing unit 108.

The deleting schedule, which is included in the schedule information 909, is created by having the profile generator 111 extract options for deleting programs corresponding to program capacity defined by the schedule controller 105 from a group of programs stored in the program storing unit 107.

To determine the program capacity, the schedule controller 105 may refer to the storing controller 106 for the remaining capacity (hereinafter referred to as “storing information 910”) of the program storing unit 107. After presenting the schedule information 909, the schedule controller 105 receives information for changes and confirmation from the viewer (hereinafter referred to as “schedule control information 908”).

When the schedule information 909 is presented to the viewer via the display 104, the schedule control information 908 is sent via the remote-control-unit input section 101 to the schedule controller 105. When the schedule information 909 is presented to the viewer and the schedule is confirmed, the schedule controller 105 sends a request for storing or deleting programs, according to the schedule information 909, to the storing controller 106. If, during storing or deleting programs, any schedule changes requested by the viewer or caused by program extension may occur, the schedule controller 105 re-creates the schedule information in the same way as that described above.

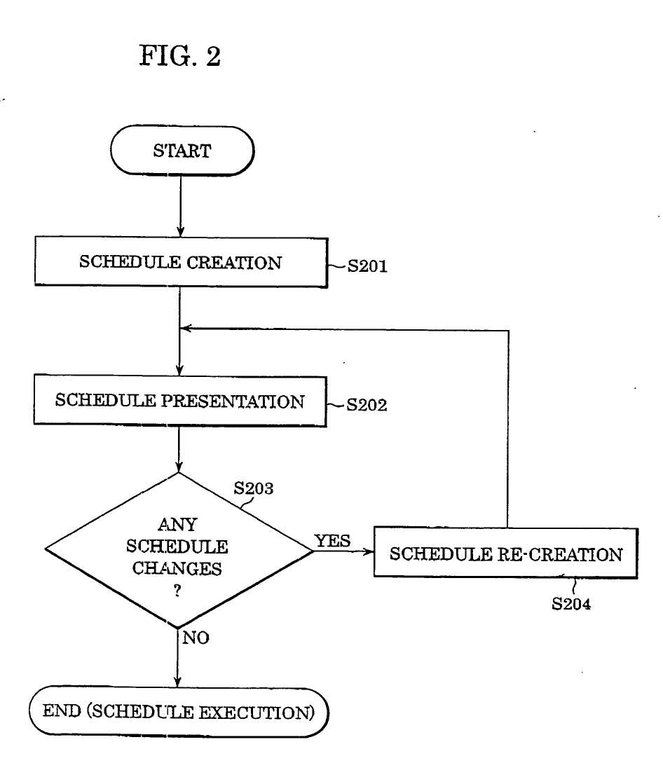

A process of program storing by the storing apparatus 10 will now be described. FIG. 2 is a flowchart showing a program storing process as one aspect of the present invention. The program storing process is carried out through the steps of schedule creation (step S201), schedule presentation (step S202), a check whether there are any schedule changes (step S203), and schedule re-creation (step S204).

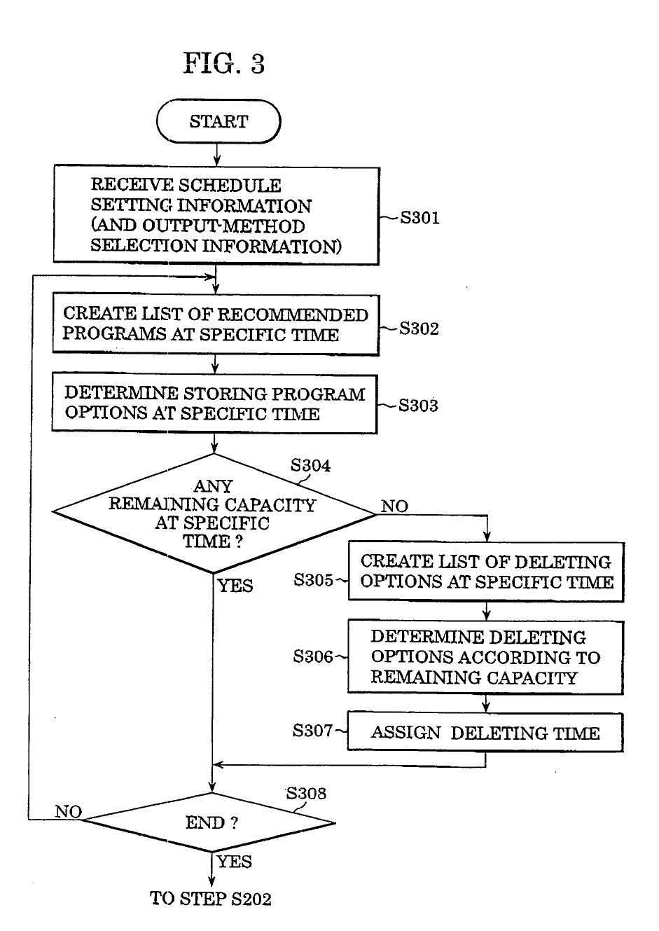

FIG. 3 is a detailed flowchart showing the process of schedule creation at step S201 in FIG. 2. To create a schedule, the schedule controller 105 receives the schedule setting information 906 from the user-setting information controller 110 (step S301) to obtain the duration and timing of the schedule creation. When the creation timing is reached, the schedule controller 105 sends a request for a list of recommended programs at the specific time period to the profile generator 111. In response to the request, the profile generator 111 extracts, according to the profile information based on an analysis of the viewer's preferences, recommended programs from the program-related information 903 stored in the program-related-information storing unit 108, creates a list of the recommended programs and sends the list (included in storing/deleting recommendation information 907 in FIG. 1) to the schedule controller 105 (step S302).

Based on the obtained list, the schedule controller 105 determines storing program options at the specific time period (step S303). The number of options is determined based on the schedule setting information 906. The maximum number of options is the number of programs that can be simultaneously stored in the storing apparatus 10. The storing program options are normally determined, from the list, in order of recommendation. If no recommended program exists in the list, the number of storing program options is zero.

When the storing program options at the specific time period are determined, the schedule controller 105 refers to the storing controller 106 for the capacity available in the program storing unit 107 at the specific time period (step S304). If the capacity is sufficient for storing the storing program options, the confirmation of the completion of the schedule creation is performed (step S308). In step S308, when the schedule creation until the end of the duration set in the schedule setting information 906 has been completed, the process proceeds to the schedule presentation (step S202).

If the schedule creation for the duration set in the schedule setting information 906 has not yet been completed the process returns to step S302 to repeat the process of schedule creation described above. The ending time of the storing program options determined in step S303 becomes another specific time.

If it is determined in step S304 that the capacity available in the program storing unit 107 is not sufficient for the storing program options to be stored, the schedule controller 105 sends a request for a list of deleting programs at a specific time to the profile generator 111. In response to the request, the profile generator 111 extracts, according to the profile information based on an analysis of the viewer's preferences, programs to be deleted from the program contents 904 stored in the program storing unit 107, creates a list of recommended deleting programs at a specific time, and sends the list (included in the storing/deleting recommendation information 907 in FIG. 1) to the schedule controller 103 (step S305).

When the list of deleting programs is received, the schedule controller 105 determines the deleting options according to the capacity required for storing (step S306). The deleting program options are normally determined from the list, in order of recommendation. The number of deleting options varies depending on the storing capacity required. When the deleting options have been determined in step S306, deleting time is assigned to each of the deleting options determined (step S307). The deleting time to be assigned may include both date and time, or only date. The deleting time to be assigned falls within the range between a specific time to the end of the program to be stored. When the assignment of the deleting time is completed in step S307, the confirmation of the completion of the schedule creation is performed (step S308) and the above-described process is carried out.

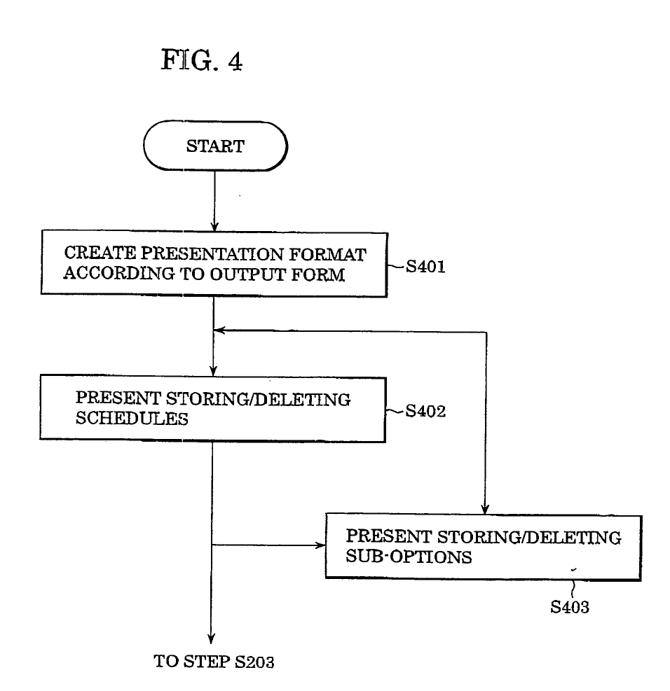

FIG. 4 is a detailed flowchart showing a process of schedule presentation at step S202 in FIG. 2. After the completion of the creation of storing and deleting schedules, the schedule controller 105 performs processing according to output forms set in the schedule setting information 906 (step S401). For example, schedule data is converted to a presentation format for a selected output form. When the output timing defined in the schedule setting information 906 is reached the storing and deleting schedules are presented in the selected form (step S402).

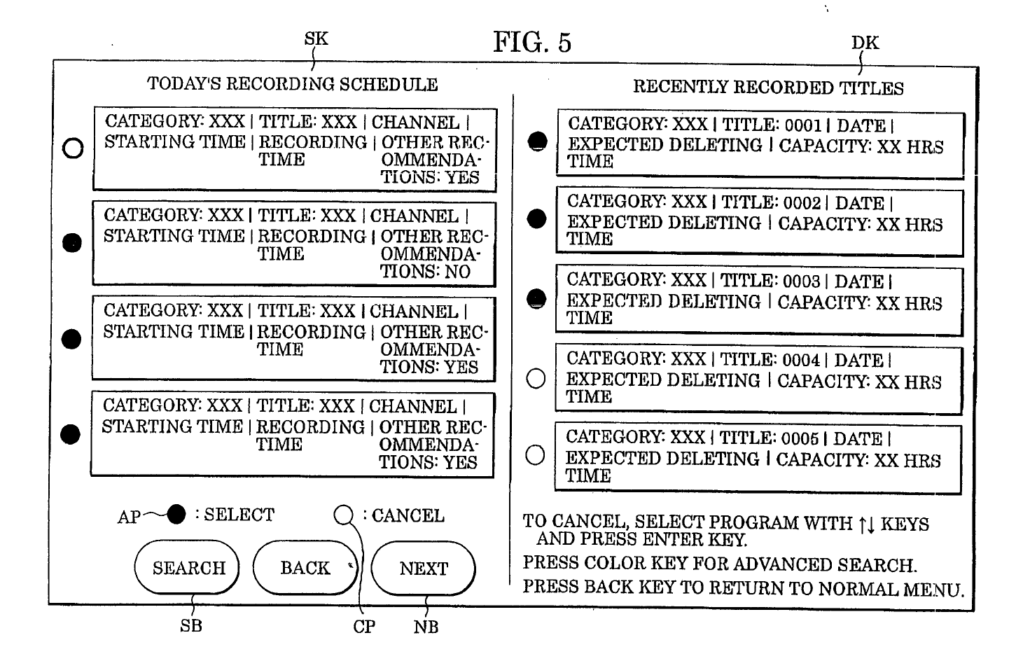

FIG. 5 shows an example of the presentation of a storing schedule SK and a deleting schedule DK. The storing schedule SK and deleting schedule DK in FIG. 5 are presented on the assumption that the output form is a television screen. Only one receiving tuner is assumed to be provided, and the storing schedule SK and the deleting schedule DK are presented at the same time. In the present embodiment, the storing schedule SK is presented on the left and the deleting schedule DK is presented on the right.

The viewer uses a remote-control unit to manipulate the screen shown in FIG. 5. Referring to FIG. 5, a portion focused on using the remote-control unit is indicated by a heavy line. The viewer checks the storing schedule SK and performs cancellation if unwanted programs are listed. In the screen shown in FIG. 5, if a program to be stored is cancelled, a selection mark (with color) AP for the program is changed to a cancellation mark (colorless) CP.

In addition, the viewer checks the deleting schedule DK and performs cancellation if unwanted programs are listed or any scheduled time should be changed. In the screen shown in FIG. 5. If a program to be deleted is cancelled, the selection mark (with color) AP is changed to the cancellation mark (colorless) CP.

Then, a “NEXT” button NB is selected to determine the schedule change. If no schedule change is required, the “NEXT” button NB is selected without prior operation. When the “NEXT” button NB Is selected, the process of schedule presentation is temporarily ended and the confirmation of changes in the storing schedule SK and deleting schedule DK is performed (step S203).

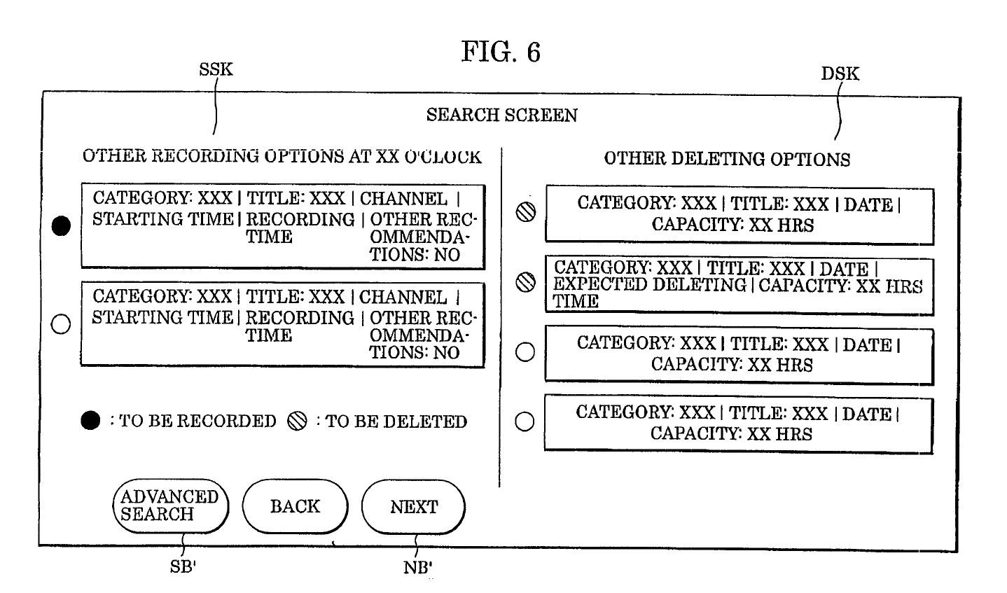

In FIG. 5, the viewer selects a “SEARCH” button SB if no program to be stored or program to be deleted is listed. When the “SEARCH” button SB is selected, sub-options of storing programs or deleting programs are presented (step S403). FIG. 6 shows an example of the presentation of storing program sub-options SSK and deleting program sub-options DSK. The storing program sub-options SSK are included in the list of storing programs created in step S302 in the process of schedule creation Similarly, the deleting program sub-options DSK are included in the list of deleting programs created in step S305 in the process of schedule creation. These sub-options vary depending on the storing program or deleting program selected on the screen shown in FIG. 5.

In FIG. 6, the viewer changes storing programs or adds deleting programs. The operation is basically the same as that described with reference to FIG. 5. In FIG. 6, if any change is made and the “NEXT” button NB′ is selected, the change is reflected and the process returns to step S402. If any storing program is changed, a storing program existing in the overlapping time period no longer appears. If any deleting program is added, on the other hand, a deleting program in the overlapping time period may still be presented.

Then, if no preferred storing program sub-options SSK or deleting program sub-options DSK are listed in FIG. 6, the viewer selects an “ADVANCED SEARCH” button SB′. When the “ADVANCED SEARCH” button SB′ is selected, the screen switches to an “ADVANCED SEARCH” mode (not shown) where the program contents 904 to be broadcasted and the program contents 904 already stored on the program storing unit 107 can be searched.

As described above, when the process of schedule presentation is completed in step S402, the confirmation of changes in the storing schedule and deleting schedule is performed (step S203). If there are no changes, both the storing schedule and deleting schedule are determined. Thus, some program contents 904 are stored according to the storing schedule, while other program contents 904 stored in the program storing unit 107 are deleted according to the deleting schedule.

If there is any schedule change in step S203, schedule re-creation is performed (step S204). The schedule re-creation is made such that the schedule is consistent with the changes made by the viewer in the process of schedule presentation. If a schedule change may result in a lack of capacity in the program storing unit 107 for storing programs to be stored, re-creation of the deleting schedule is carried out automatically.

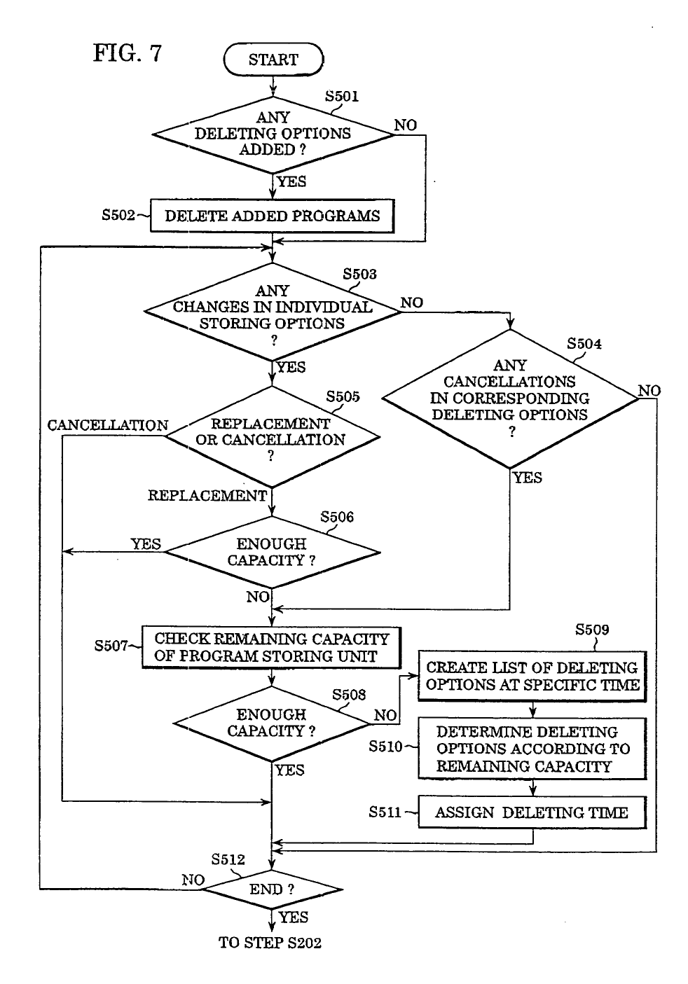

FIG. 7 is a detailed flowchart showing the process of schedule re-creation at step S204 in FIG. 2. First, the schedule controller 105 determines whether or not any options for deleting programs are added by the viewer (step S501). If it is determined that a deleting option is added, the program is deleted (step S502). If it is not determined that a deleting option is added, the process skips step S502.

The confirmation of changes in individual storing programs in the storing schedule will now be performed (step S503). If there is no change with respect to the storing programs presented in FIG. 5, the confirmation of changes in individual deleting programs in the corresponding deleting schedule is performed (step S504). If there is no change with respect to the deleting programs presented in FIG. 5, the confirmation of the completion of the schedule re-creation is performed (step S512).

If the confirmation of changes in all the storing programs in the schedule has been completed in step S512, the process returns to the process of the schedule presentation If the confirmation of changes in all the storing programs in the schedule has not yet been completed, the confirmation of changes in the next storing program is performed in step S503. In step S504, if any deleting program in the deleting schedule is cancelled, the capacity of the program storing unit 107 at the corresponding time is checked (step S507), and it is determined whether or not a sufficient capacity for storing the storing programs is available (stop S508).

If there is a capacity sufficient for storing the storing programs, the confirmation of the completion of the schedule re-creation is performed (step S512). If the capacity is not sufficient for storing the storing programs, a list of deleting options at the corresponding time is created to determine other deleting programs. The process is the same as that in step S305 and Its subsequent steps in the schedule creation.

In response to a request from the schedule controller 105 for a list of deleting programs for a specific time, the profile generator 111 selects, according to the profile Information based on an analysis of the viewer's preferences, programs to be deleted from the program contents 904 stored in the program storing unit 107, and creates a list of recommended deleting programs for a specific time (step S509).

When the list of deleting programs is received, the schedule controller 105 determines the deleting options according to the capacity required for storing (step S510). When the deleting options have been determined, deleting time is assigned to each of the deleting options determined (step S511). When the assignment of the deleting time is completed, the prcocess proceeds to step S512 where the confirmation of the completion of the schedule re-creation is performed, and the same process as described above is performed.

In step S503, if there is any change in the storing programs, it is determined whether the change is a replacement with another program In the same time period, or just the cancellation of a storing program (step S505) In the case where the change is the cancellation of a storing program, the process proceeds to step S512 where the confirmation of the completion of the schedule re-creation is performed, and the same process as described above is performed. In the case where the change is the replacement with another program in the same time period, it is determined whether or not there is any change in the corresponding deleting programs, and whether or not the change results in an increase in capacity (step S506).

If it is determined in step S506 that any corresponding deleting program is cancelled, the process proceeds to step S507 and the same process as described above is performed. The process similarly proceeds to step S507 and the same process as described above is performed, if it is determined in step S506 that there is no change in the corresponding deleting programs but the capacity is not sufficient for storing the storing program changed. If it is determined in step S506 that there is no change in the corresponding deleting programs and sufficient capacity is available for storing the storing program changed, the process proceeds to step S512 where the confirmation of the completion of the schedule re-creation is performed, and the same process as described above is performed.

When the schedule re-creation in step S204 has been completed and the consistency with schedule changes is ensured, the schedule presentation process in step S202 is performed again. In this case, the deleting schedule presented may differ from the schedule intended by the viewer, since the deleting schedule presented has achieved consistency with the schedule changes after the process of schedule re-creation described above. Therefore, the viewer needs to check the presented screen again so as to determine whether or not any changes are required. The schedule is determined if no change is required, and the above-described process is performed again if any changes are required.

Thus, the program storing process and its detailed processes, that is, the schedule creation (step S201), schedule presentation (step S202), and schedule re-creation (step S203) performed by the storing apparatus 10 have been described. The schedule re-creation is effective if a schedule is changed, during the process of storing or deleting programs according to the schedule, by the viewer or by program changes.

According to the present embodiment, in the program-storing method for automatically storing broadcast programs in the storing apparatus, the storing schedule and deleting schedule are created and simultaneously presented, before being implemented, to the viewers thereby allowing the viewer to easily check the programs to be stored or to be deleted in advance. Moreover, the viewer can easily achieve consistency between desired programs and the storing capacity. Furthermore, the deleting schedule is created to minimize the risk of stored programs being accidentally deleted, and to give priority to the deletion of programs less important to the viewer, thereby allowing the viewer to easily perform setting, and thus promoting effective use of the storing apparatus.

Moreover, since sub-options of storing and deleting programs, as well as the storing and deleting schedules are presented, it becomes less necessary for the viewer to search all the information of broadcast programs and stored programs, and to perform cumbersome settings for individual contents.

The storing schedule and deleting schedule may be presented in output forms other than the television screen. In the embodiment described above, the storing schedule and deleting schedule (hereinafter referred to as “schedule information 909”) are presented via the display 104 included in the storing apparatus 10 or a display apparatus directly connected to the storing apparatus 10. Another output form may be a mobile device of the viewer.

When a mobile device is used, the storing apparatus 10 selects an output form. The schedule controller 105 in the storing apparatus 10 obtains output-method selection information 906A from the user-setting information controller 110 at the time of schedule creation. The output-method selection information 906A is information set by the viewer, similarly to the schedule setting information 906, and designates a destination to which the schedule information 909 is sent.

The schedule controller 105 identifies the destination based on the output-method selection Information 906A and sends the schedule information 909 at the output timing specified by the schedule setting information 906. The schedule information 909 is sent via the modem 103 in the storing apparatus 10. In the case of the mobile device, the schedule information 909 may be sent via e-mail or other methods.

When the schedule information 909 is received by the mobile device, the viewer performs manipulations on the schedule information 909 and sends a response back to the storing apparatus 10. In this case, such information is sent as the schedule control information 908 via the modem 103 to the schedule controller 105. After sending the schedule information 909, the storing apparatus 10 stops implementing the schedule if no response is received from the viewer for a certain period of time. The viewer may configure settings not to send a response to the storing apparatus 10 if no change to the schedule information 909 is required. Under such settings, the storing apparatus 10 implements storing and deleting operations according to the schedule information 909, if no response is received, after sending the schedule information 909, for a certain period of time.

A web terminal may also be used as an output form. In this case, the viewer selects web terminal as the output form from a plurality of output forms for the storing apparatus 10. The storing apparatus 10 sends the schedule information 909 created on a web site, at the output timing specified by the schedule setting information 906, via the modem 103.

Using the web terminal, the viewer accesses the web site to check and manipulate the schedule information 909. Information on schedule changes is sent via the modem 103 to the schedule controller 105. After sending the schedule information 909, the storing apparatus 10 stops implementing the schedule if Moo response is received from the viewer for a certain period of time. Alternatively, depending on the settings, the storing apparatus 10 implements storing and deleting operations according to the schedule information 909, if no response is received for a certain period of time, after sending the schedule information 909.

Thus, when mobile devices and web terminals are used as output forms for the schedule information 909, effects achieved are similar to the case described above. In the case where the display 104 is used, the viewer needs to be near the storing apparatus 10 to check the storing and deleting schedules when they are presented. Even after the implementation of storing and deleting operations, the viewer needs to be near the storing apparatus 10 if any schedule changes are required. When mobile devices and Web terminals are used as output forms, such constraints can be avoided, and viewer convenience is improved.

While the present invention has been described with reference to what are presently considered to be the preferred embodiments, it is to be understood that the invention is not limited to the disclosed embodiments. Rather, the invention is intended to cover various modifications and equivalent arrangements included within the spirit and slope of the invention.

The control circuit for the storing apparatus 10 may be a signal processing circuit exclusively for executing the process flow described above, or may include a memory circuit for storing a program for executing the process flow described above and a signal processing circuit for executing the program.

This application claims priority from Japanese Patent Applications No. 2003-412775 filed Dec. 11, 2003 and No. 2004-346614 filed Nov. 30, 2004 which are hereby incorporated by reference herein.

1. A signal generating method comprising the steps of:
determining broadcast programs to be stored in a storing apparatus during a predetermined time period;
determining broadcast programs, from the broadcast programs stored in the storing apparatus, to be deleted during the predetermined time period; and
generating signals for simultaneously displaying information on the broadcast programs to be stored and information on the broadcast programs to be deleted.

2. The signal generating method according to claim 1, wherein said step of determining broadcast programs to be stored is performed based on one of a setting, made by a user, of the storing apparatus, and a history of the setting made by the user.

3. The signal generating method according to claim 1, wherein said step of determining broadcast programs to be deleted is performed based on at least one of a setting, made by a user, of the storing apparatus, a history of the setting made by the user, and a playback history of the broadcast programs stored in the storing apparatus.

4. A signal generating method comprising the steps of:
determining a date, time, or both a date and time, for deleting broadcast programs stored in a storing apparatus: and
generating signals for displaying the date, time, or both the date and time, for deleting the broadcast programs.

5. The signal generating method according to claim 4, further comprising a step of changing the date, time, or both the date and time, for deleting the broadcast programs.

6. The signal generating method according to claim 4, wherein the broadcast programs to be deleted are selected from a plurality of broadcast programs stored in the storing apparatus, as broadcast programs to be deleted, said method further comprising a step of changing a deleting schedule for the selected broadcast programs.

7. A program for signal generation comprising the steps of:
determining broadcast programs to be stored in a storing apparatus during a predetermined time period;
determining broadcast programs, from the broadcast programs stored in the storing apparatus, to be deleted during the predetermined time period; and
generating control signals for simultaneously displaying information on the broadcast programs to be stored and information on the broadcast programs to be “deleted.

8. A program for signal generation comprising the steps of:
determining a date, time, or both a date and time, for deleting broadcast programs stored in a storing apparatus; and
generating control signals for displaying the date, time, or both the date and time, for deleting the broadcast programs.

9. A storing apparatus for storing broadcast programs, comprising:
a storing device for storing broadcast programs; and
a control circuit for determining broadcast programs to be stored in the storing device during a predetermined time period, determining broadcast programs, from the broadcast programs stored in the storing device, to be deleted during the predetermined time period, and generating control signals f or simultaneously displaying information on the broadcast programs to be stored and information on the broadcast programs to be deleted.

10. A storing apparatus for storing broadcast programs, comprising:
a storing device for storing broadcast programs; and
a control circuit for determining a date, time, or both a date and time, for deleting the broadcast programs stored in the storing device.

11. A display apparatus comprising:
a control circuit for determining broadcast programs to be stored in a storing device during a predetermined time period, determining broadcast programs, from the broadcast programs stored in the storing device, to be deleted during the predetermined time period, and generating control signals for simultaneously displaying information on the broadcast programs to be stored and information on the broadcast programs to be deleted; and
a display device for displaying according to the control signals.

12. A display apparatus comprising:
a control circuit for determining a date, time, or both a date and time, for deleting broadcast programs stored in a storing device; and
a display device for displaying a date, time, or both a date and time, for deleting the broadcast programs stored in the storing device.

13. The signal generating method according to claim 6, wherein said step of changing a deleting schedule comprises at least one of canceling the deleting schedule, changing the scheduled date or time of deletion, and changing the scheduled date and time of deletion.

14. A storing method for automatically storing a plurality of broadcast programs in a storing apparatus, comprising the steps of:
creating a storing schedule for storing the broadcast programs during a predetermined time period;
creating a deleting schedule for deleting, during the predetermined time period, broadcast programs stored in the storing apparatus;
presenting, at a predetermined timing, the storing schedule and the deleting schedule;
changing contents of at least one of the storing schedule and the deleting schedule presented in said presenting step; and
re-creating the deleting schedule based on the contents changed in said changing step.

15. A storing apparatus for automatically storing a plurality of broadcast programs, comprising:
a program-related-information storing unit for storing program-related information related to the plurality of broadcast programs;
an operation history controller for maintaining histories related to storing and playback of the plurality of broadcast programs as operating history information, based on the program-related information and operating history information;
a profile generator for analyzing the operating history information to generate profile information and a storing schedule listing the plurality of broadcast programs to be stored during a predetermined time period, and generating a deleting schedule listing one or more of the plurality of stored broadcast programs to be deleted; and
a schedule controller for controlling the storing schedule and deleting schedule to be displayed at a predetermined timing.
